(19) United States
(12) Patent Application Publication
(10) Pub. No.: US 2016/0273487 A1
(43) Pub. Date: Sep. 22, 2016

(54) NACELLE WITH A THRUST REVERSER DEVICE WITH MAINTAINED MOVEABLE CASCADES

(71) Applicant: AIRCELLE, GONFREVILLE L'ORCHER (FR)

(72) Inventor: Guy Bernard VAUCHEL, HARFLEUR (FR)

(73) Assignee: AIRCELLE, GONFREVILLE L'ORCHER (FR)

(21) Appl. No.: 15/054,669

(22) Filed: Feb. 26, 2016

Related U.S. Application Data
(63) Continuation of application No. PCT/FR2014/052142, filed on Aug. 29, 2014.

(30) Foreign Application Priority Data
Aug. 30, 2013 (FR) 13/58333

(51) Int. Cl. F02K 1/58; F01D 25/24; F02K 1/80

(52) U.S. Cl. CPC F02K 1/58; F02K 1/805; F01D 25/24; F05D 2220/323; F05D 2240/50

(57) ABSTRACT

A thrust reverser device is provided that includes movable thrust reverser cascades that move between a direct jet position and a thrust reversal position driven by a movable cowl able to be translated along the axis of an aircraft nacelle. The thrust reverser cascades cooperate with stiffening and sealing members of said thrust reverser device.

### CROSS-REFERENCE TO RELATED APPLICATIONS

This application is a continuation of International Application No. PCT/FR2014/052142, filed on Aug. 29, 2014, which claims the benefit of FR 13/58333, filed on Aug. 30, 2013. The disclosures of the above applications are incorporated herein by reference.

### FIELD

The present disclosure relates to a nacelle with a thrust reverser device having movable cascades.

### BACKGROUND

The statements in this section merely provide background information related to the present disclosure and may not constitute prior art.

An aircraft is moved by several turbojet engines each housed in a nacelle also accommodating a set of auxiliary actuating devices related to its operation and providing various functions when the turbojet engine is running or stationed. These auxiliary actuating devices comprise particularly a thrust reverser mechanical system.

A nacelle has generally a tubular structure comprising an air inlet upstream of the turbojet engine, a median section intended to surround a fan of the turbojet engine, a downstream section accommodating the thrust reversal means and intended to surround the combustion chamber of the turbojet engine, and is generally provided with an ejection nozzle, the outlet of which is located downstream of the turbojet engine.

Modern nacelles are intended to accommodate a bypass turbojet engine able to generate, by means of blades of the rotating fan a hot air flow (also called primary flow) coming from the combustion chamber of the turbojet engine, and a cold air flow (secondary flow) which circulates outside the turbojet engine through an annular passage, also called a flow path, formed between a fairing of the turbojet engine and an inner wall of the nacelle. The two air flows are ejected from the turbojet engine from the back side of the nacelle.

The role of a thrust reverser is, during the landing of an aircraft, to improve the braking capacity thereof by redirecting forward at least one portion of the thrust generated by the turbojet engine. In this phase, the thrust reverser obstructs the cold flow path and directs the latter forward of the nacelle, thereby generating a counter-thrust which is added to the braking of the aircraft wheels.

The means implemented to carry out this reorientation of the cold flow vary according to the thrust reverser type. However, in all cases, the structure of a thrust reverser comprises movable cowls displaceable between, on the one hand, a deployed position in which they open within the nacelle a passage intended for the diverted flow, and on the other hand, a retraction position in which they close this passage. These cowls may fulfill a function of deflection or simply of activation of other diverting means.

In the case of a thrust reverser with cascades, the reorientation of the air flow is performed by cascade vanes, the cowl having only a simple sliding function aiming to uncover or cover these cascades. Additional blocking doors, also called flaps, activated by the sliding of the cowling, generally allowing a closure of the flow path downstream of the cascades so as to allow the reorientation of the cold flow towards the cascades.

These flaps are pivotally mounted on the cowl sliding between a retracted position in which they ensure, with said movable cowl, the aerodynamic continuity of the inner wall of the nacelle and a deployed position in which, in the thrust reversal situation, they come close at least partially the annular channel in order to divert a gas flow towards the cascade vanes uncovered by the sliding of the movable cowl.

The pivoting of the flaps is guided by connecting rods fastened, on the one hand, to the flap, and on the other hand, to a fixed point of the inner structure delimiting the annular channel.

Multiple forms of thrust reverser devices with cascades are known, particularly forms relating to new installation structures of thrust reverser cascades. Such cascades are conventionally mounted on the nacelle so as to be movable between a direct jet position where they are inactive, that is to say that they are not crossed by an air flow to be diverted, and a thrust reversal position where they are active, that is to say that they divert the air flow to be diverted. Most of the time, these cascades are driven by the movement of the movable cowl when it shifts from its retracted position to its deployed position and vice versa, but they may also be driven by a mechanism distinct from the movable cowl.

The movable cascades and their movement mechanism are mostly described in the state of the art, without any indication nor adapted solution for their installation and their integration relative to other components of a thrust reverser device.

### SUMMARY

The present disclosure includes an aircraft nacelle, in particular to carry out a maintaining of the movable cascades despite the stresses, and more particularly to handle the aerodynamic stresses they are subjected to.

The present disclosure also provides a simplified, robust, lighter weight, less expensive, and more reliable aircraft nacelle.

To this end, the present disclosure concerns an aircraft nacelle comprising a thrust reverser device, an outer fixed cowl directly upstream of the thrust reverser device, the thrust reverser device comprising thrust reverser cascades movable between a direct jet position and a thrust reversal position driven by a movable cowl able to be translated along the axis of the nacelle, the nacelle being noteworthy in that the thrust reverser cascades cooperate with stiffening and sealing means of said thrust reverser device.

According to other features of the present disclosure, the thrust reverser device includes one or more of the following features considered alone or in all possible combinations:
the stiffening and sealing means comprise a structural upstream frame for the upstream connection of the sets of movable cascades having in particular a substantially Z-shaped section and a generally annular shape connecting the sets of movable cascades to each other by their upstream end;
a portion of the front frame is used as a stop, the lower web of the Z-profile of the structural frame for the upstream connection of the sets of movable cascade is turned downstream and comes into contact on a partial or complete stop of the front frame;
the stiffening and sealing means comprise bearing fittings disposed between a front frame of the thrust reverser device and an outer cowl such as a fan cowl allowing to stabilize the cascades and thus to maintain a good coaxiality between the outer cowl and the thrust reverser device;
each bearing fitting comprises a soleplate fastened or integral with the front frame, a radially oriented body and disposed in a clearance space between two sets of movable cascade vanes and an outer sector fastened or integral with said outer cowl, or outer bearing frame of the outer cowl;
the cascades are guided in translation by means of rollers rotatably fastened on the bearing fittings so as to roll on the longitudinal bars of a soleplate of set of movable cascades, between which each bearing fitting guides the longitudinal sliding of the sets of movable cascade vanes;
a rising ramp is provided on the rolling surface of the sets of movable cascades for the rollers before they reach the reverse jet position downstream of the nacelle;
the stiffening and sealing means comprise radial, axial or oblique fastening means of the downstream edge of the sets of movable thrust reverser cascades to the movable cowl, the fastening being for example of the screw-nut type;
the stiffening and sealing means comprise an attached or integrated sealing support including a spoiler having a securing portion of the downstream end of the sets of movable cascades by their soleplate, depending on whether the fastening of the cascades on the movable cowl (40) is radial or axial, or oblique;
the spoiler also cooperates with a supporting bracket of pivot fittings which carries the axis of blocking flaps.

This solution provides a robust and reliable thrust reverser structure, easily and quickly integrated on the nacelles of aircrafts, andit allows improved resistance to deformations of the structure.

This solution also provides a lighter weight structure allowing to improve the specific fuel consumption of the engine, the operation costs are less, the carbon footprint of the aircraft is reduced, and the production cost is lower due to the coherent structure of the movable cowl.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 represents a section of the nacelle to the right of the cascades showing the disposition of fittings according to the present disclosure;

FIGS. 2a and 2b represent respectively a partial front section and a side view of a set of movable cascades and of a fitting in one form of the present disclosure;

FIGS. 3a and 3b represent a solution for the upstream connection of the cascades represented in a direct flow position and then in a reverse flow position;

FIGS. 4a and 4b represent both a form of the upstream connection and a form of the fittings and the sets of cascades in a direct flow position and a reverse flow position in perspective;

FIG. 5 represents a partial section of an assembly allowing to maintain the cascades in reverse jet position online;

FIGS. 6a and 6b represent a front view and a side view in partial sections of another assembly allowing to maintain the cascades in reverse jet position online;

FIGS. 7 and 8 represent two forms of the downstream connection of the cascades;

FIGS. 9 and 10 represent two other forms of the downstream connection of the cascades.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

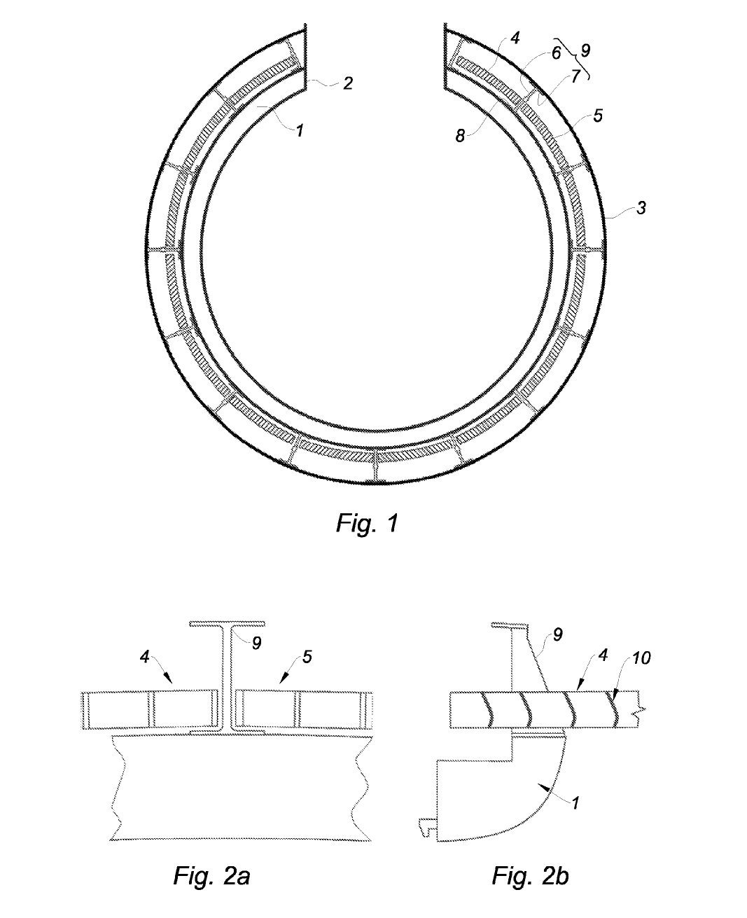

In FIG. 1, it is represented a section of the nacelle to the right of the cascades showing the disposition of the bearing fittings of the fan cowl with the front frame. The structure of the thrust reverser represented herein is then of the 0-Duct type, however, the present disclosure is directly applicable to a thrust reverser of the C-Duct type, among others.

In this form, the movable cascades cooperate with bearing fittings which participate in stiffening and sealing means of the movable cascades in at least one position of the thrust reverser in direct jet mode and one position of the thrust reverser in reverse jet mode.

At least three fittings are distributed around the circumference of the nacelle, at the periphery of the front frame to ensure a reduced balanced holding of a bearing outer frame of the fan cowl. In the example of FIG. 1, fifteen substantially radial fittings are disposed between a front frame 1 and a fan cowl 3. A section represented in the upper portion of FIG. 1 is interrupted for the passage of the fastening pylon of the nacelle to the aircraft (not shown).

One purpose of these stiffening and sealing means includes providing a good coaxiality and holding/resistance to the forces of any outer fixed cowl directly upstream of the thrust reverser device, such as a fan cowl 3. It is represented in the following figures a bearing outer frame.

Between each fitting, such as the fitting 9, are radially disposed on the circumference of the nacelle of the sets of movable cascades such as the sets 4 and 5 on either side of the fitting 9. The sets of the movable cascades are located outside the direct jet when the thrust reverser is inactive and are crossed by the reverse jet, when the thrust reverser is active. In this case, the movable cascades and the fan cowl have been displaced from a retracted position to a position in which the direct air flow path, previously blocked by blocking flaps (not shown), crosses the sets of cascades and, diverted by each mounted and profiled cascade in its set of cascades is returned by the outside of the nacelle towards the nacelle inlet section.

Each fitting, such as the fitting 9 essentially comprises a soleplate/flange 8 endowed with fastening means to the front frame 1, a central body/web 6 radially extending and crossing the gap between two sets of cascades and an outer sector/flange 7 endowed with fastening means to the inner face of the fan cowl 3.

In a particular form, the bearing portion of the fittings is carried on a bearing outer frame of the fan cowl or on a bearing continuous peripheral outer structure of the fan cowl.

A clearance is deliberately created between two cascades in order to allow a continuous passage over at least the length of displacement of the movable cowl. A particular application will define the required number and location of the clearances between cascades to allow the passage of reinforcement fittings.

In one form, the soleplate of the fitting is fastened to the main structure of the front frame. The central body is comprised in the dimension of the clearance between cascades, it is dimensioned to hold/transfer loads at the interface with the fan cowl. The outer sector is defined as being able to interface with a bearing continuous peripheral outer structure with the fan cowl.

The fitting is made of a material selected so as to withstand the forces undergone by the fitting.

In one form, the central body of the fitting is integral with the structure of the front frame. In another form, the bearing sector of the fan cowl is an integral portion of the structure of the front frame and also the bearing continuous peripheral outer structure of the fan cowl.

In FIGS. 2a and 2b, it is respectively represented a partial front section and a side view of a set of movable cascades and of a fitting 9 in one embodiment of the present disclosure.

The fitting 9 is disposed between two sets of movable cascades 4 and 5, the body of the fitting having a width slightly smaller than the clearance between the two sets of cascades so as to allow their relative displacements. The soleplate of the fitting 9 is fastened to the front frame 1. In the side view of FIG. 2b, it is represented a series of curved cascades such as the cascade 10, which are mounted parallel to each other on a soleplate of cascades so as to form a set of movable cascades 4.

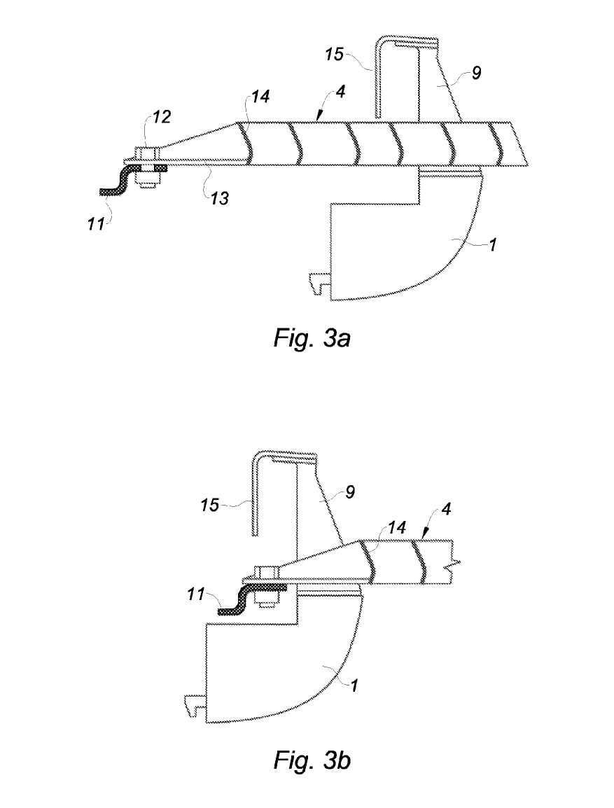

In FIGS. 3a and 3b, it is represented a solution for the upstream connection of the sets of movable cascades such as the set of cascades 4 represented in a reverse flow position (FIG. 3a) and then in a direct flow position (FIG. 3b).

The sets of movable cascades are all connected upstream on a ring 11 or structural frame for the upstream connection of the sets of movable cascades, which in one form is in one-piece at the periphery.

The structural frame for the upstream connection of the sets of movable cascades is assembled upstream of the structure of the front frame 1, and it is mounted under the soleplate of cascades 13 or above depending on the desired definition or the positioning in height relative to the front frame 1 using bolts such as 12. The shape of the structural frame 11 for the upstream connection of the sets of movable cascades may vary according to the expected loads. In one form, the structural frame 11 for the upstream connection of the sets of movable cascades has a lower web of the Z-profile as shown.

The set of movable cascades 4 is defined in length relative to the thrust reversal stroke required for the ejection performances of the flow and so that the upstream frame 1 remains in front of the bearing fittings 9 of the fan cowl 3 in the thrust reversal position.

The forces of the reverse flow are aimed at spacing the cascades such as the cascade 14 in the set of movable cascades 4, outwards and at creating deformations and constraints on the non-structural parts.

In order to provide assistance in resisting deformation, that is to say to contribute to the stiffness of the sets of movable cascades, the structural frame 11 for the upstream connection of the sets of movable cascades has a moment of inertia which introduces an additional stiffness when applying the aerodynamic forces by the reverse flow.

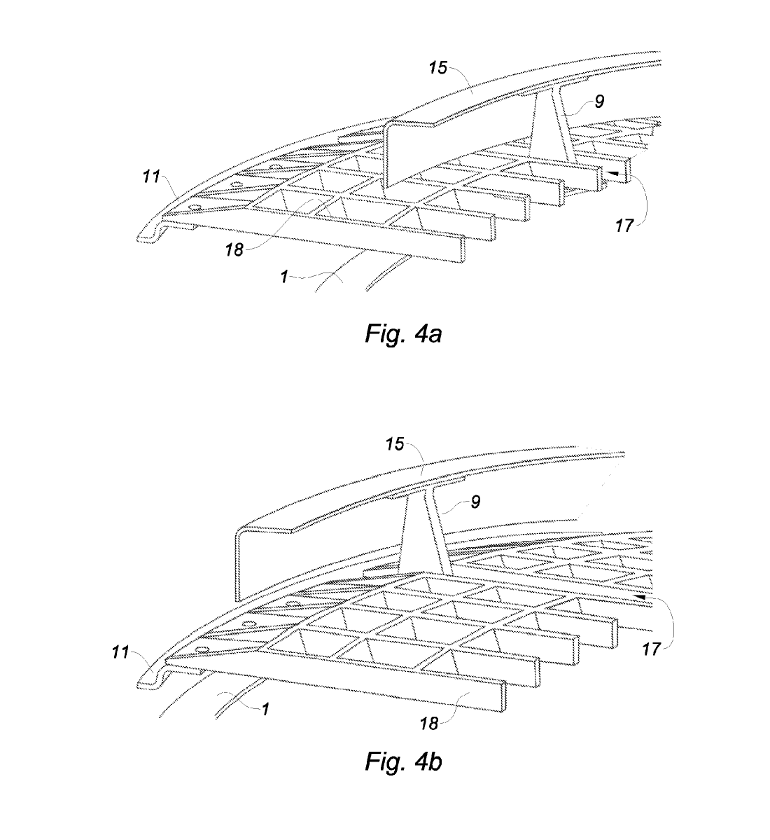

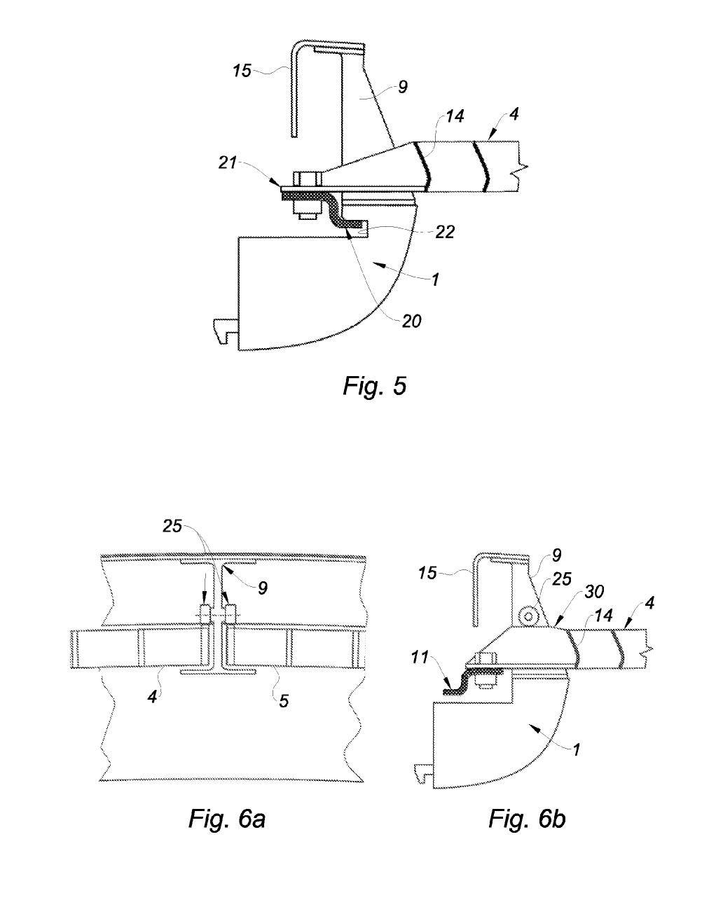

In FIGS. 4a and 4b, it is represented partial perspective views of the sets of cascades endowed with a structural frame 11 for the upstream connection of the sets of movable cascades according to the same dispositions as those of FIGS. 3a and 3b. It is noticed more specifically the presence of a clearance 17 between the two sets of movable cascades which are disposed on either side of the body 9 of the bearing fitting 15 of the bearing frame of the fan cowl. Each set of movable cascades consists of a soleplate having an annular portion relative to the central axis of the nacelle integrated with a truss of crossed bars between which are disposed (not visible) the actual curved cascade vanes. It may be seen the structural frame 11 for the upstream connection of the sets of movable cascades upstream of each set of movable cascades. The soleplate of each set of movable cascades also comprises bars which extend parallel to the central axis of the nacelle such as the bar 18 and cross bars (not referenced) which allow forming frames in which the actual cascade vanes are mounted. It is noted that the clearance 17 between two sets of movable cascades disposed on either side of a bearing fitting 9 is constituted between two bars of soleplate of set of movable cascades and that it has a length measured along the direction of the central axis of the sufficient nacelle to allow the displacement of the set of movable cascades between the reverse jet position (FIG. 4a) and the direct jet position (FIG. 4b).

In the stiffening and sealing means of the sets of movable cascades, it is also proposed to hold up or maintain the upstream end of the cascades at least in the complete reversal position, even over all or part of the stroke. Such arrangement has been represented in one form by a configuration in which a portion of the front frame 1 is used as stop. In this configuration, as an example, the lower web 22 of the Z-profile of the structural frame 20 for the upstream connection of the sets of movable cascades is turned downstream and comes into contact on a partial or complete stop 22 of the front frame 1.

In the stiffening and sealing means of the sets of movable cascades, it is also proposed to hold up the upstream end of the cascades over all or part of the stroke of the sets of movable cascades. In FIGS. 6a and 6b which are a front view and a side view in partial sections of another assembly allowing to maintain online the cascades in the reverse jet position, rollers 25 have been added on either side of the body of the bearing fitting 9 which are intended to roll on at least one part of the longitudinal soleplate bars of a set of movable cascades 4 and a set of movable cascades 5, such as the bar 18 (FIG. 4a) disposed as close as possible to the clearance 17 allowing the translation of the set of movable cascades.

In FIG. 6b, a rising ramp 30 is provided on the rolling surface of the sets of movable cascades for the rollers 25 before they reach the reverse jet position downstream of the nacelle which allows pressing the set of movable cascades 4 against the front frame 1 thus improving the stiffness of the thrust reverser device assembly in the reverse jet position. According to the disposition of seals, this disposition is also opportune to the improvement of the sealing of the thrust reverser device during the translation of the sets of movable cascades.

It is noted that a structural frame 11 for the upstream connection of the sets of movable cascades in the disposition described in FIGS. 3a, 3b and 4a, 4b has been combined with the disposition of the rollers 25 on the bearing fitting 9. This combination is better than the unique disposition of the structural frame for the upstream connection of the sets of movable cascades, of fittings or fitting rollers. But, only one of these dispositions would be conceivable to carry out the stiffening and sealing means.

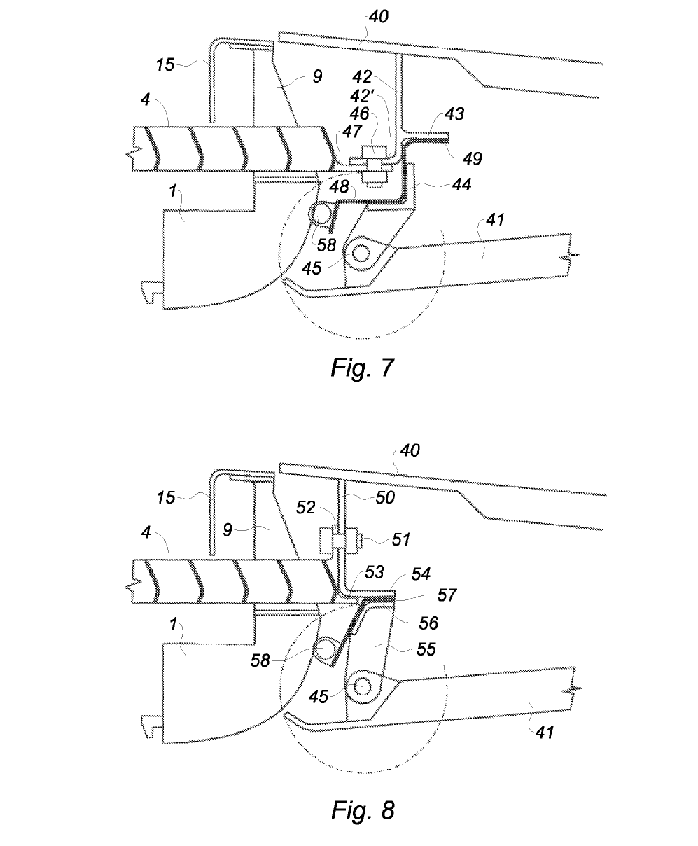

In FIGS. 7 and 8, it is represented two forms of the downstream connection of the cascades, or sets of movable cascades. The downstream connection has been developed with the aim of participating in stiffening and sealing means of the thrust reverser device of the nacelle of the present disclosure, also so as to improve the maintaining of the cascades to the exerted aerodynamic forces, particularly in reverse jet mode.

The thrust reverser device comprises as known a movable cowl 40 whose inside of the upstream edge facing the sets of movable cascades such as the set of movable cascades 4, which has been represented in FIGS. 7 and 8 in the direct jet position, the air coming from the fan (not represented crossing the direct main flow path) is released downstream of the nacelle in the direction of the central axis of the nacelle.

The stiffening and sealing means comprise an attached or integrated sealing support including a spoiler 42, 50, 61 having a securing portion 42′, 50, 63 of the downstream end of the sets of movable cascades by their soleplate 47, 52, 60, depending on whether the fastening of the cascades on the movable cowl 40 is radial or axial, or oblique.

The upstream portion of the movable cowl, due to the location of the cascades upstream of its structure, may have a radially continuous constitution and significantly reinforce the movable structure. It forms a spoiler which may be integrated with the structure of the movable cowl or attached by fasteners thereon. It may include different configurations of shapes allowing different interfaces with the cascades depending on application requirements.

The forces undergone by the cascades in reverse jet mode are longitudinal and radial, giving an oblique component outwardly relative to the axis of the nacelle.

In one first form, an axial assembly with the soleplate of the cascade placed under the heel of the spoiler allows absorbing the aerodynamic forces to the direction of the central axis of the nacelle.

The circumferential downstream edge 47 of the soleplate of each set of movable cascades, such as the set 4, has an axial orientation downstream which is joined with a flap 42 parallel to a spoiler 42 secured to the inside of the movable cowl 40 on its disposed upstream end. The circumferential downstream edge 47 is bolted 46 from place to place on this flap 42′ of the spoiler 42. The sealing 58 of the thrust reverser device of the present disclosure is reinforced at the downstream side by a Z-shaped seal support 48 a wing 49 of which is supported on an axial flap 43 of the spoiler 42. A corner of the seal support 48 is intended to be housed on a bracket 44 mounted on a pivot fitting in connection with a hinge 45 of blocking flap 41 which is intended, when shifting to the reverse jet mode, to come intercept the direct air flow path to direct thereby the air flow coming from the fan through the sets of movable cascades such as 4, when the movable cowl 40 has been translated downstream, extracting the sets of movable cascades such as 4 downstream beyond the fitting 9 and the front frame 1.

It is noted that the blocking flap 41 comprises a spoiler which, when the blocking flap 41 moves down, rises in abutment under the downstream edge of the soleplate of the movable cascades 4, ensuring both the stiffening and the sealing of the downstream portion of the thrust reverser device.

In one second form, an assembly facing as an option a heel-pad placed under the spoiler of the cowl still allows regaining the direction of the aerodynamic force.

In FIG. 8, the spoiler 50 has a radial portion perpendicular to the central axis of the nacelle on which a radial edge 52 directed outwardly of the central axis of the nacelle is bolted 51 from place to place.

The spoiler 50 has an axial return 54, in the direction of the central axis of the nacelle and directed downstream which still receive a heel-pad of the same orientation 53 as the soleplate of the set of movable cascades 4.

A seal support 57 is disposed under the axial return 54 between it and a bracket 56 carried by a lever 55 mounted on the hinge 45 of the blocking flap 41.

The following two figures show a slanting assembly, represented on the spoiler in order to comprise in the same spoiler structure the sealing support but which may be also carried out by the bottom of the soleplate.

For the sealing between the inner flow path and the outer nacelle, several solutions exist, some of which are schematically represented in the figures hereinafter.

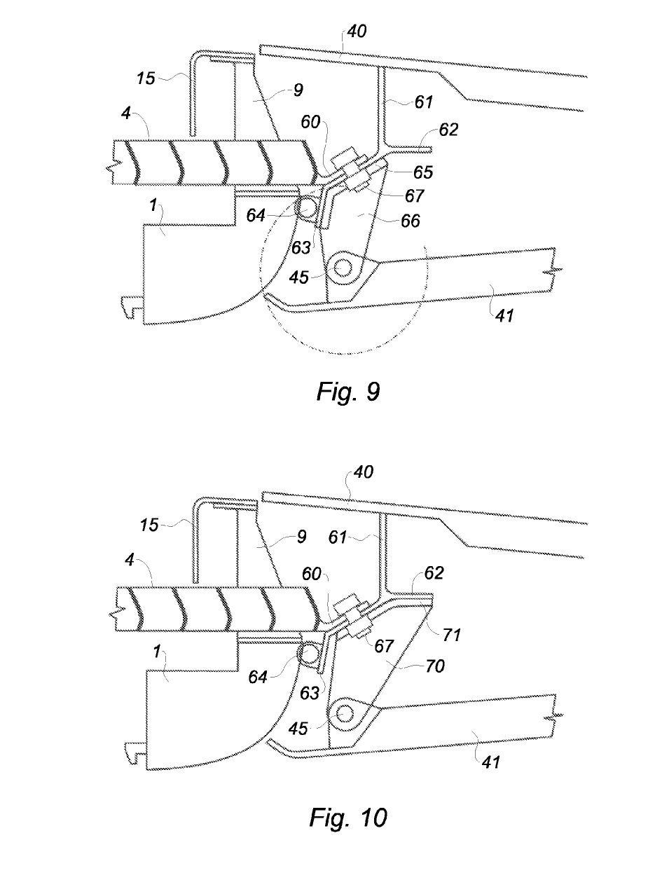

In FIG. 9, it is carried out stiffening and sealing means which comprise a continuous support means attached on the spoiler 61 of movable cowl 40 but may also support the pivot fittings 45 of the blocking flaps 41.

The downstream edge 60 of the soleplate of the set of cascades 4 has an oblique slope relative to the direction of the central axis of the nacelle. The spoiler 61 has after its radial attachment (vertical in the drawing) to the inner face of the movable cowl 40, two portions 63 having a first slope directed upstream parallel to the slope of the downstream edge of the soleplate of the set of cascades which it receives and one end of a slope more steeper towards the central axis of the nacelle and upstream. The downstream edge 60 is bolted 67 on the first slope of the two portions 63 of spoiler while a flap 62 of the spoiler returns parallel to the central axis of the nacelle downstream.

The two oblique portions 63 of the spoiler also receive a supporting bracket 65 which carries the pivot fitting 66 which carries the axis 45 of the blocking flap 41.

In FIG. 10, it is carried out stiffening and sealing means which comprise the support integrated with the structure of the spoiler 61 which may also support the pivot fittings of the flaps. The downstream edge 60 of the soleplate of the set of movable cascades 4 is also obliquely folded to come bolt on the two tilted portions 63 of the spoiler 61. The pivot fitting 70 carries a bent supporting bracket 71 which comes bearing both on the flap 62 of axial orientation and on the first oblique slope of the two oblique portions 63 of the spoiler 61.

The soleplate downstream edge, its fastening by bolting to the spoiler 61 the shape of the bracket of the pivot fitting of blocking flap, as a whole, thus allow according to the various possible geometries as those described hereinabove improving the stiffness and the sealing of the thrust reverser device of the nacelle of the present disclosure.

The present disclosure provides an improved definition of positioning of the seal which must be as low as possible in contact with the structure of the diverting edge of the front frame in order to generate lower forces resulting from the self-opening of the movable cowl.

The installation assembly of the cascades on the one hand on the upstream structure of the movable cowl and on the other hand upstream with a continuous frame allows ensuring a strong structural cohesion allowing to reduce the overall weight of the components without changing the general behavior of the thrust reverser.

Different stiffening and sealing means shown in this application may be used alone or in association with each other or be mixed.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An aircraft nacelle comprising a thrust reverser device, an outer fixed cowl directly upstream of the thrust reverser device, such as a fan cowl, the thrust reverser device comprising movable thrust reverser cascades between a direct jet position and a thrust reversal position driven by a movable cowl able to be translated along the axis of the nacelle, wherein the thrust reverser cascades cooperate with stiffening and sealing members of said thrust reverser device.

2. The nacelle according to claim 1, wherein the stiffening and sealing members comprise a structural upstream frame for the upstream connection of the of movable thrust reverser cascades having a substantially Z-shaped cross-section and a generally annular shape connecting the movable thrust reverser cascades to each other by upstream ends thereof.

3. The nacelle according to claim 2, wherein a portion of a front frame of the thrust reverser device is used as a stop, a lower web of the Z-shaped structural upstream frame is turned downstream and comes into contact with the front frame.

4. The nacelle according to claim 1, wherein the stiffening and sealing members comprise bearing fittings disposed between a front frame of the thrust reverser device and an outer cowl, thereby stabilizing the cascades and thus maintaining coaxiality between the outer cowl and the thrust reverser device.

5. The nacelle according to claim 4, wherein each bearing fitting comprises a soleplate fastened or integral with the front frame, a radially oriented body disposed in a clearance space between two sets of movable thrust reverser cascades, and an outer sector fastened or integral with said outer cowl.

6. The nacelle according to claim 4, wherein the cascades are guided in translation by rollers rotatably fastened on the bearing fittings so as to roll on longitudinal bars of a soleplate of a set of movable cascades, between which each bearing fitting guides longitudinal sliding of the movable thrust reverser cascades.

7. The nacelle according to claim 6, wherein a rising ramp is provided on a rolling surface of the movable thrust reverse cascades for the rollers before the rollers reach a reverse jet position.

8. The nacelle according to claim 1, wherein the stiffening and sealing members comprise radial, axial or oblique fastening members of a downstream edge of the movable thrust reverser cascades to the movable cowl.

9. The nacelle according to claim 8, wherein the fastening members are a screw-nut type.

10. The nacelle according to claim 8, wherein the stiffening and sealing members comprise an attached or integrated sealing support including a spoiler being secured to a downstream end of the movable thrust reverser cascades by a soleplate.

11. The nacelle according to claim 10, wherein the spoiler cooperates with a supporting bracket of pivot fittings.
